(19) United States
(12) Patent Application Publication
(10) Pub. No.: US 2008/0225739 A1
(43) Pub. Date: Sep. 18, 2008

(54) Method and Apparatus for Monitoring Events in Network Traffic

(75) Inventors: Fergal Toomey, County Dublin (IE); Brian McGurk, Dublin (IE); Ian Edward Dowse, County Dublin (IE); Matthew Charles Davey, Dublin (IE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: CORVIL LIMITED, Dublin (IE)

(21) Appl. No.: 11/722,698

(22) PCT Filed: Dec. 23, 2004
(86) PCT No.: PCT/IE04/00179

§ 371 Date: Jun. 27, 2007

(51) Int. Cl. G01R 31/08

(52) U.S. Cl. 370/252

(57) ABSTRACT

A method of monitoring events in network traffic is described herein, in accordance with various embodiments. The method may provide for the reduction in the number of network traffic samples that need to be analysed in order to determine performance criteria for the traffic in the network. By selecting specific samples as representative of the requirements of all the traffic, it may be possible to more efficiently and quickly provide an analysis of the activity of the network.

### FIELD OF THE INVENTION

Embodiments of the present invention relate to network traffic and in particular to the events in the measurements of network traffic that contribute to packet delay, packet loss and queuing. Embodiments of the invention particularly relate to a method and apparatus for monitoring these events and using the monitored events as an evaluation tool in the performance of the network.

### BACKGROUND

Traffic traversing a packet-based communication network will experience delay and occasional packet loss. These conditions degrade the performance of the network as experienced by users. Both packet loss and delay can be caused by queuing on router and switch interfaces in the network, as well as by other factors. Queuing occurs at speed mismatch points, where traffic may enter a router/switch at a faster speed than it can leave, and also at points in the network where traffic from multiple sources can be directed towards a single router/switch interface. Packets which arrive to find a queue ahead of them will be delayed as they wait to reach the head of the queue, and may be dropped if there is no buffer space left on the router/switch to store them.

The extent of queuing on a given interface can be reduced by providing more interface bandwidth, i.e. by increasing the speed at which the interface can transmit data packets. Bandwidth, however, costs money. Network operators are therefore interested in knowing how much bandwidth is needed to ensure an acceptable level of packet delay and loss.

“Quality of Service” (QoS) targets, indicating limits on allowable packet delay and loss, often form part of the Service Level Agreement offered by a network operator to its customers or users. These QoS targets may be either deterministic or statistical in nature. An example of a deterministic QoS target is the statement that “no packet will be delayed by more than 200 milli-seconds”. An example of a statistical QoS target is the statement that “no more than 1% of packets will be delayed by more than 200 milli-seconds”. Ultimately network operators need to know how much bandwidth is needed in the various parts of their network to ensure that the stated QoS targets are achieved.

Unfortunately, network operators today have limited ability to determine the impact of queuing on QoS. Queues on network interfaces frequently build up and disappear on very short timescales, for example over periods of tens or hundreds of milli-seconds. However, routers and switches do not provide performance measurements at these timescales. Typically, the network operator can only inspect the total amount of traffic (measured in bytes and packets) traversing an interface over timescales of seconds or longer. These measurements provide no insight into the extent of queuing.

Measurements of network traffic made at very short timescales will generate large quantities of data which may then be processed in order to recover information about the bandwidth needs of the traffic. For example, the bandwidth required to meet a deterministic delay QoS target can be computed as follows. For each interval of time, determine from the measurements what volume of traffic (in bytes) arrived at the measurement point during the interval. Divide this volume by the sum of the interval length and the delay bound. Finally maximise the resulting values over all time intervals of any length. The resulting bandwidth value is the minimum bandwidth required to ensure that the delay bound is never violated. It will be appreciated that the measurement and analysis of the volume of data necessary to define such a bandwidth value is not a trivial task in that large amounts of computational processing is required to provide the values in near real-time.

The bandwidth required to meet a deterministic packet loss target can be computed using a similar approach. Suppose that the available buffering can store a certain maximum volume of traffic. We need to ensure that the length of the queue awaiting transmission never exceeds this limit. The transmission bandwidth required to achieve this can be computed as follows. For each interval of time, determine the volume of traffic which arrived during the interval and subtract from this the value of the queue length limit. Divide the result by the duration of the time interval. Finally maximise the resulting values over all time intervals of any length.

Both of these computations require examination of the traffic at many timescales in order to find the time intervals over which the most bandwidth is needed to prevent congestion. In practice, we are presented with a discrete set of traffic measurements. Therefore, only those time intervals which begin and end at a traffic measurement can be examined. If measurements are made infrequently this information will not be sufficient to determine the bandwidth requirement of the traffic. If measurements are made very frequently, then the number of distinct time intervals which must be examined to determine bandwidth requirement becomes unmanageable. There is a need therefore for a method of reducing the number of measurements without losing important information about the traffic, while simultaneously providing the measured data in a form which allows bandwidth requirement to be computed efficiently.

Reducing the amount of measured data in this way is best performed close to the measurement point, in order to avoid any need to transmit large volumes of data to a remote station. The measurement point may be either a dedicated appliance inserted into the network for the specific purpose of measurement (a network probe for example), or it may be a router or switch which is also forwarding traffic. In either case, the method of processing the data must be computationally lightweight in order to allow a large number of traffic streams to be processed on the same device. This requirement exists because routers/switches generally have many interfaces. Traffic destined for each interface must be processed separately.

Traffic destined for the same interface is often subdivided into separate classes, each of which is given a separate priority by the router/switch according to its requirements and business relevance. For the purpose of estimating bandwidth requirement, each class must be measured individually.

Traffic in the same network class may originate from multiple different customers or applications, and the network operator may wish to analyze each customer's/application's traffic separately.

We note that processors on commercially available routers and switches frequently have no support for floating point arithmetic. There is therefore a further need for a method for reducing the number of measurements without losing important information about the traffic, while simultaneously providing the measured data in a form which allows bandwidth requirement to be computed efficiently and which advantageously can be implemented close to the measurement point. If this could be implemented without a requirement for floating point arithmetic then this would be a further advantage.

### SUMMARY

A first embodiment of the invention may provide a method for taking a set of traffic measurements and selectively discarding some of them so as to provide a reduced set of traffic measurements, in a fashion which ensures that the bandwidth requirement of the traffic can be computed from the reduced set to the same precision with which it can calculated from the original set. Furthermore, embodiments of the invention may provide for the reduced set of measurements being the minimal subset which has this property. The method may be computationally efficient thereby enabling an efficient analysis of the traffic to be performed, and can be implemented as an integer-only algorithm, making it suitable for use on processors which have no floating point support.

In accordance with the teachings of embodiments of the invention, it may be possible to provide for a reduction in the required number of samples necessary to measure the traffic being received at the input to the router or some other node in the network. Using a multi-operation approach to the processing of the traffic, in a first operation, embodiments of the invention may provide for an analysis of traffic samples so as to produce as an output a second sequence of samples in the same form. The function of this operation may be to reduce the number of samples while preserving important information about bandwidth requirement contained in them. In particular, during any sufficiently long analysis window, the interval of time over which the deterministic bandwidth requirement of the traffic attains its maximum value may appear in the output samples as a pair of consecutive samples. This property may make it particularly easy to compute the bandwidth required by the traffic from the output samples alone.

This reduced set can then be used in a further processing operation. In one application, this processing operation can provide for a calculation of the bandwidth requirement at that node. By analyzing the samples produced by the sample reduction procedure of the first operation, in accordance with the teaching of embodiments of the invention, it may be possible to provide an estimate of the traffic's bandwidth requirement. If a quality of service (QoS) target is to be applied is a deterministic QoS target, then a second operation may comprise simply finding in each analysis window the pair of consecutive output samples from the first operation which maximize the test function value. The maximum test function value may then be an estimate of the traffic's bandwidth requirement over the analysis window. The process of computing this maximum value can be implemented by applying a test function to each successive pair of output samples as they are produced and simply recording the maximum.

As an alternative to determining the traffic bandwidth requirement in a deterministic fashion, embodiments of the invention may also provide for a determination of the traffic in a statistical fashion.

The methodology of embodiments of the invention may be desirably implemented in accordance with the teachings of claim 1. Advantageous embodiments may be provided in dependent claims thereto. Embodiments of the invention may also provide a network analysis tool according to claim 30, with advantageous embodiments to the tool provided in dependent claims thereto.

### BRIEF DESCRIPTION OF THE DRAWINGS

Exemplary embodiments of the present invention will now be described with reference to the accompanying drawings in which:

FIG. 1 is a schematic of a node in a packet data network, in accordance with various embodiments.

FIG. 2 is an example of a flow sequence for use in an implementation of embodiments of the present invention so as to provide for a reduction in the number of samples that need to be analysed to provide a representation of the traffic activity in the network.

FIG. 3 is an example of the processing of a reduced sample set to provide a deterministic analysis of the traffic, in accordance with various embodiments.

### DETAILED DESCRIPTION OF THE DRAWINGS

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

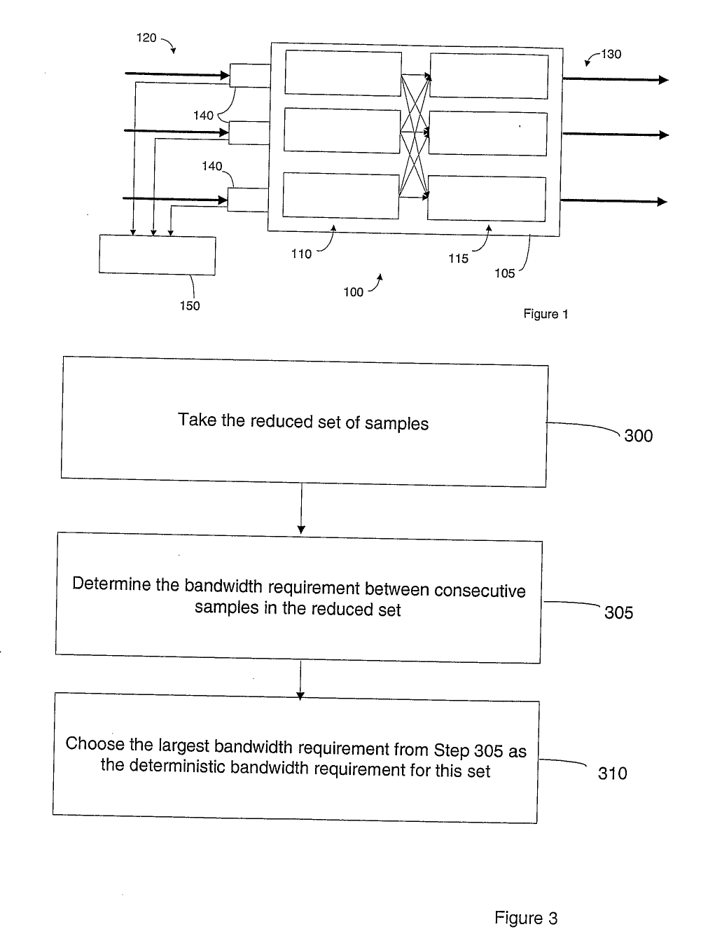

FIG. 1 shows in schematic form an implementation of embodiments of the present invention on a packet data network 100. The methodology of embodiments of the present invention may require a first measurement of a sequence of traffic measurements and may produce as output a second sequence of measurements in same form. The methodology may desirably be implemented at the point of measurement which may be a network router/switch or appliance 105 within the network 100. The router may be configured to couple a plurality of incoming links 120 through incoming 110 and outgoing 115 buffers to a corresponding number of outgoing links 130. The router/switch or appliance may use simple traffic counters 140 and a clock (included within the counter block 140) to generate the measurements to supply as inputs to a measurement processor 150 according to embodiments of the present invention. Each measurement may comprise a timestamp, a byte count, and a packet count. The counts may reflect the number of bytes and packets observed in the traffic up to the time indicated in the timestamp. These data measurements may then be processed in accordance with the methodology of embodiments of the present invention to provide an output in the same form as the original sequence of traffic measurements, but reduced in number. The measurement processor 150 is shown as a separate entity to the router but it may be appreciated that the methodology may be implemented in a software or hardware module on the network router/switch or appliance.

The output of the measurement block processor methodology may also comprise a sequence of traffic measurements in the same form. The function of the processing provided by embodiments of the present invention may be to reduce the measurements to the minimum set needed to describe the bandwidth required by the traffic. Therefore, the output may comprise fewer measurements than the input, but the bandwidth requirement of the traffic can still be determined from the output measurements. These measurements can then be further processed in either an on-line or off line fashion to provide specific analysis of the traffic at that node in the network. If implemented in an on line fashion, then such a processing may be effected using software and/or hardware components located within the measurement processor module 150.

In order to achieve this reduction in measurements the technique provided by embodiments of the present invention may perform a selection based on the burstiness of the traffic within an interval between two samples. Burstiness refers to the relation between the highest and the average traffic values. A high burstiness value may imply great bit-rate variation. In order to effect this measurement, the technique according to embodiments of the present invention may determine the highest traffic value using a “bandwidth test function”. This function can take several different forms. The choice of which form to use may depend on the type of QoS target which is to be achieved. All forms may take as input two traffic measurements and may produce as an output a bandwidth value computed from the information in the measurements, and from the chosen QoS target. For example, a packet delay test function may be obtained by taking the total volume of traffic occurring between the two traffic measurements (as determined from the byte counts contained in the measurements), and dividing this by the sum of the elapsed time between the measurements (given by their timestamps) and a specified delay bound parameter. It will be noted that the resulting value may represent the minimum bandwidth which would be required to prevent any packet during the interval between the measurements being delayed by more than the delay bound, under the assumptions that the queue is empty at the beginning of the interval and that the traffic during the interval arrives as a perfectly smooth stream. It will be further noted that the true bandwidth required to prevent the delay bound ever being violated can be computed by taking the maximum value of the test function over all possible pairs of measurements (or at least, this is the “best” estimate of the true value which can be computed using the supplied measurements).

An alternative test function which may be used is a packet loss test function which may be obtained by the taking the sum of the volume of traffic between the measurements and a queue limit parameter, and then dividing this sum by the elapsed time between the measurements. Again, it may be noted that the result represents the minimum bandwidth which would be required to prevent the queue length from exceeding the given limit at any time during the measurement interval, under the assumptions that the queue may be empty at the beginning of the interval and that the traffic during the interval arrives as a perfectly smooth stream. We also note that the true (or best-estimate) bandwidth required to prevent packet loss can again be computed by taking the maximum value of the test function over all possible pair of traffic measurements.

Depending on the final analysis of the traffic required, the desired bandwidth test function may then be used in combination with average traffic values for the sampled traffic so as to provide the reduced set of samples for subsequent analysis. The average traffic values may be provided by use of an average bit rate function, an example of which will be discussed later.

The sequence of output measurements produced by methodology implemented on the measurement processor 150 may have the following properties:
1. The output measurements may be a subset of the input measurements.
2. The maximum value of the test function over all consecutive pairs of output measurements lying on or between two selected output measurements may be equal to the maximum value obtained by applying the test function to all pairs, consecutive or otherwise, of input measurements falling on or between the selected pair.

If any of the output measurements are discarded, then property 2 may no longer hold. In other words, the output measurements may be a minimal set of measurements having this property.
Once this first operation of the methodology of embodiments of the present invention has been effected, the resultant reduced set of samples may be used in subsequent processing to provide direct analysis of the traffic at that measurement point within the network.

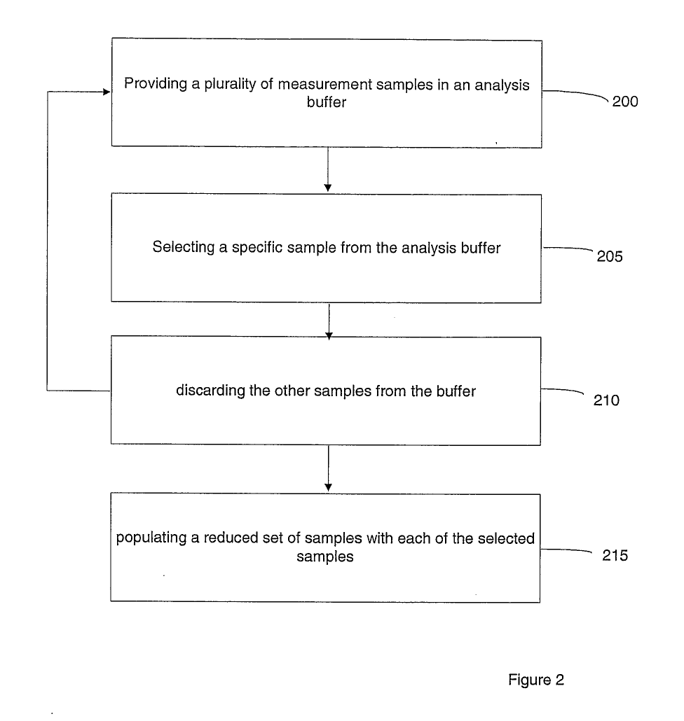

This process of the first operation will now be described with reference to a labelled set of traffic samples, and with reference to the flow sequence of FIG. 2, in accordance with various embodiments. For a sample labelled ‘i’ we denote by Vᵢ the traffic volume measurement in bytes contained in sample i and by Tᵢ the timestamp of sample i. For two samples labelled i and j, where sample i occurs prior to sample j, we let V(i,j) represent the difference Vⱼ-Vᵢ and T(i,j) represent the difference Tⱼ-Tᵢ. In words, V(i,j) represents the volume of traffic observed in the flow between samples i and j, and T(i,j) represents the elapsed time between the two samples. In exemplary network traffic, a plurality of these samples may pass a node over time. In accordance with the technique of embodiments of the present invention the samples may be placed in an analysis buffer (block 200).

Once in the analysis buffer, the bandwidth test function mentioned above may take as an input any two traffic samples i and j (i prior to j) and produces as output a bandwidth value, denoted s(i,j), computed from the information in i and j, and from the chosen QoS target. As mentioned above, the form of the test function may depend on the type of QoS target which is to be achieved. If the aim is to control the number of packets suffering a delay greater than a specified value D, then the function s(i, j)=V(i, j)/(T(i, j)+D) may be used. This form is referred to later as a ‘packet-delay’ test function. If the aim is to control the number of packets dropped when the buffer space available is B bytes, then the function s(i, j)=(V(i, j)−B)/T(i, j) may be used. This form is referred to later as a ‘packet-loss’ test function.

It will be noted that in both cases the bandwidth required to ensure that the QoS target is achieved for all packets can be approximated by maximizing the value of s(i,j) over all samples made during the time interval of interest. The time interval of interest will be referred to henceforth as the ‘analysis window’.

The procedure may also make use of the average bit-rate observed between two samples. The average bit-rate between samples i and j, denoted r(i,j), is just the value of V(i,j)/T(i,j). We observe that for any three samples i, j, and k (occurring in that order but not necessarily consecutively), the value of r(i,k) may lie between the values of r(i,j) and r(j,k). Furthermore r(i,k) may not be equal to r(i,j) unless it may also be equal to r(j,k). These observations follow from the fact that r(i,k) can be written as a convex combination of the values r(i,j) and r(j,k).

It will also be observed that, for either of the two bandwidth test functions introduced above, s(i,k) may be a convex combination of r(i,j) and s(j,k). Therefore its value may lie between the latter two values, and it may be not equal to either of them unless all three are equal. The value s(i,k) may also be a convex combination of the values of s(i,j) and r(j,k). These facts will be used frequently in the description which follows.

It will be further noted that during any sufficiently long analysis window, the pair of input samples i and j which yield the maximum value of the bandwidth test function s(i,j) may appear as a pair of consecutive output samples.

Each sample supplied as input may be copied into a buffer within the measurement processor module 150. The samples may then be analysed within the buffer to select a sample as an output sample (block 205). When a sample is produced as output, all input samples prior to the output sample may be discarded from the buffer (block 210), while the output sample and subsequent input samples may be retained. The very first sample supplied as input may always be immediately produced as an output sample and retained in the buffer. At all subsequent times therefore the algorithmic technique utilised by the methodology of embodiments of the invention may always have at least one sample in the buffer. Samples may be stored in the buffer in the order in which they are supplied as input. In practice a ‘circular’ buffer may normally be used. The selected samples may then be used as the population of a reduced set of samples each of which are identical to the equivalent sample originally provided to the analysis buffer (block 215).

A preferred implementation of embodiments of the invention may provide this reduced set by providing and maintaining four variables which we label ‘start’, ‘end’, ‘min’, and ‘max’. The values of these variables may refer to positions in the buffer, although we will also use them to label the traffic samples stored in these buffer positions. Initially they all may point to the same position, namely the position of the very first input sample which has just been reproduced as an output sample. Subsequently their values may be updated as follows.
1. Advance the value of end to point to the next input sample in the buffer. If there are no more input samples then the procedure may wait at this point for the next input sample to be supplied.
2. If min and max are equal to start, then set both of them may be equal to end and go to operation 1.
3. If r(start,end) is smaller than or equal to r(start,min) then set min equal to end.
4. If s(start,end) is larger than or equal to s(start,max) then set max equal to end.
5. If s(start,max) is larger than r(start,min) then execute the following operations:
a. Produce either min or max (whichever is the earlier sample) as the next output sample.
b. Discard all input samples in the buffer prior to the sample which was just produced as output.
c. Set start, end, min, and max to point to the sample just produced as output.
6. Repeat from operation 1.

The variables can be considered as having the following meanings:
The variable start may point to the earliest sample which has been processed while determining which sample to output next.
The variable end may point to the latest sample which has been processed.
The variable min may point to the sample i prior to end which may minimize the value of r(start, i) (updated in operation 3).
The variable max may point to the sample i prior to sample end which may maximize the value s(start, i) (updated in operation 4).

We refer to the condition in operation 5 which triggers production of the next output sample as the ‘output condition’.

We can now demonstrate our assertion that this procedure will find the interval of maximum test function value during any sufficiently long analysis window, and produce that interval as a pair of consecutive output samples. Suppose that a is the first input sample and b is the last input sample during the analysis window, and suppose that within the window the test function attains its maximum value on a pair of input samples labelled l and r. We assume that the algorithm starts with sample a as the last output sample, so that the variable start may point to sample a. (e.g., by resetting the algorithm at the start of the analysis window, or by choosing the boundary of the analysis window to coincide with the last output sample).

Consider first the case where sample a may be also the first sample l of the maximum pair (l,r). The following argument shows that sample r may be the next output sample after sample a, provided that the analysis window may be large enough to ensure that the output condition is triggered. Thus l and r may appear as a consecutive pair of output samples.
1. So long as max points to a sample at or prior to sample r, the value of s(start,max) may be no larger than s(start,r).
2. So long as min points to a sample prior to sample r, the value s(min,r) may be smaller than s(start,r). Since s(start,r) lies between r(start,min) and s(min,r), it follows that r(start,min) may be larger than s(start,r). Note that this may be also true if sample min points to sample r itself.
3. Therefore r(start,min) may remain larger than s(start,max) until either min or max points to a sample coming after sample r. The output condition may not be triggered until this happens, implying that end may reach the first sample after sample r before termination is triggered.
4. We may assume that the analysis window may be sufficiently long that the output condition may be triggered before the end of the window is reached. In this case variable max may point to sample r when the output condition is triggered, because s(start,r) may be the largest value of s over any interval in the window.
5. Since max may point to sample r, min may point to a sample after sample r, since otherwise the output condition may not be triggered. Therefore sample r may be produced as the next output sample.

Next, we consider the case where sample l does not coincide with sample a, but appears at some later point. The following argument shows that the next output sample after sample a may be either sample l or an earlier sample.
1. The test function value s(start,r) may lie between the values r(start,l) and s(l,r), and may be smaller than s(l,r).
2. Therefore r(start,l) may be smaller than s(start,r). This implies that the output condition may be triggered when the variable end reaches sample r at the latest.
3. For any sample i lying between sample l and sample r, the value s(i,r) may be no larger than s(l,r). Since s(l,r) may lie between the values r(l,i) and s(i,r), this may mean that r(l,i) may be no smaller than s(l,r).
4. We have shown already that r(start,L) may be smaller than s(start,r) which in turn may be smaller than s(l,r), while r(l,i) may not be smaller than s(l,r). Considering r(start,i) therefore, which may lie between r(start,l) and r(,i), we see that it may be larger than r(start,l).
5. This may be true for each sample i between l and r, which may implie that the variable min may not point to any sample after sample l when the output condition is triggered. Since the output sample may be the earlier of min and max, it may therefore be sample l or an earlier sample.

Continued operation of the algorithm may eventually produce sample l, as it may not produce the same sample twice. Once sample l has been produced, the next output sample may be sample r as we have already shown. This shows that the algorithm may indeed produce the pair (l, r) as a consecutive pair of output samples, provided that the analysis window is large enough to trigger the output condition when the algorithm starts from sample l.

A number of practical issues may be considered in the implementation of this procedure. Evidently, the output condition may be triggered within the analysis window in order to ensure that the maximum test function sample pair may be produced in the output. In practice there may be a tighter constraint: the output condition may be triggered before the space in the sample buffer is exhausted, since when this occurs the algorithm may not continue its normal operation as described above.

Normally the output condition may be triggered when r(start,min) is smaller than s(start,max). Note that r(start,min) may decrease in value while s(start,max) may increase as the algorithm proceeds. The constraint of limited sample buffer space can be dealt with by triggering the output condition as soon as the sample buffer fills up, even if r(start,min) is still larger than s(start,max). The size of the buffer can be chosen to ensure that these values will be within a given range of the final values which they would have achieved if the algorithm had unlimited buffer space available. This may be done as follows.

Note that r(start,min) may be smaller than r(start,end) while s(start,max) may be larger than s(start,end) at all times. Suppose that the QoS target may be a packet-delay target with parameter D. If the samples in the buffer when it is full are sufficient to cover a total interval of time T, then s(start,end) may be equal to a fraction T/(T+D) of the value of r(start,end). For example if T is 20 times larger than D, then s(start,end) may be no smaller than 95% of the value of r(start,end). This implies that s(start,max) may also be no smaller than 95% of r(start,min). A similar calculation can be carried out if the QoS target is a packet-loss target with parameter B. If the samples in a full buffer cover a time period T, then s(start,end) may be equal to r(start,end) minus B/T when the buffer is full. The value of T can therefore be chosen to control the error between s(start,max) and the true final value it would reach if unlimited buffer space were available.

Sizing the sample buffer in this way may not guarantee that the pair of samples which maximise the test function value will be found. However it may ensure that the error between the true maximum value and the values which are actually found can be controlled. An alternative method of sizing the buffer may be to collect a representative set of traffic measurements from a network where the algorithm is to be deployed, and use them to empirically determine the buffer space needed to achieve a low risk of exhaustion. This approach may often show that the buffer space required is lower than the above calculations would indicate.

A second issue of practical concern may be the frequency with which input traffic samples should be supplied in order to attain a sufficient level of accuracy in the output. If traffic samples are supplied infrequently then the procedure may not be able to identify the (possibly short) time intervals over which the test function attains its maximum value. This issue can be analyzed as follows. Suppose that the QoS target is a delay target with parameter D, and that traffic samples are supplied at regular intervals of length τ. The test function value between two samples i and j may be V(i, j)/(T(i, j)+D) if we assume that the traffic volume V(i,j) arrived smoothly over the interval of time T(i,j). However it may be the case that this traffic volume actually arrived over a shorter interval T(i,j)−τ, but the supplied samples failed to discriminate this. In this case the actual test function value between samples i and j might more correctly be the higher value V(i,j)/(T(i, j)+D−τ). The fractional difference between the two cases is τ/(T(i, j)+D). The sampling frequency to be used in practice can therefore be identified by noting the exemplary length T of the interval which may maximize the test function value and ensure that τ/(T+D) is small. This can be done in an ‘off-line’ fashion before the reduction analysis is employed on “active” data, using representative sets of network traffic measurements, or it can be done in an ‘on-line’ fashion by adjusting the sampling interval in response to the results obtained.

It will be appreciated by the person skilled in the art that the sample reduction procedure as described here can be easily implemented in either hardware or software in its entirety as an integer algorithm, i.e. it does not require floating point arithmetic. The volume counts and timestamps contained in the traffic samples can be represented as integer values. In operations 3, 4, and 5 the algorithm may compare bandwidth values computed between specific pairs of samples. Comparing two bandwidth values V/T and V′/T′ (where V and V′ are traffic volumes, T and T′ are time intervals) may be equivalent to comparing the values V×T′ and V′×T, which may be more easily computed in an integer algorithm.

The sample reduction procedure can further be used in a ‘chaining configuration’ in which the same procedure may be applied multiple times to the traffic using different bandwidth test functions. For example, suppose one wishes to apply the procedure for a number of different packet-delay targets D₁, D₂, D₃, . . . , Dₙ where D₁ is the smallest delay target and Dₙ is the largest. This can be done by first applying the procedure to the input traffic samples using target D₁, then applying the procedure again to the resulting output samples using target D₂, and so on. The use of this configuration may be based on the fact that the input sample frequency required for accurate results is lower for higher packet-delay target, and so is the number of output samples produced. Thus applying the procedure using delay bound D₁ may remove some of the samples while retaining a sufficient number for the second application, using a larger delay bound, to produce accurate results, and so on. Using such a chaining configuration can lead to greatly reduced computational requirements relative to a parallel application of the procedure to the same input samples for each delay target.

Heretofore what has been described is a technique to reduce the number of measurement samples which may be required in order to have a representation of the traffic activity at the node in the network. Once the technique of embodiments of the present invention has been implemented to provide a reduced set of samples, what may this reduced set be used for?

In accordance with a first embodiment of a processing operation that may be applied to samples of the reduced set, embodiments of the invention may provide for the determination of the required bandwidth to meet a desired QoS target in a deterministic fashion. An example of such a deterministic analysis is provided in FIG. 3. The reduced set of samples may initially be taken as the base sample set (block 300). This set may then be processed so as to maximise the value of s(i, j) over all consecutive samples in the reduced set (block 305). Once this maximisation operation has been performed on all consecutive samples the resultant bandwidth values may be compared and the larges bandwidth value may be chosen as being the determining bandwidth for that analysis window (block 310).

An alternative to this further processing of the reduced set and in accordance with the teachings of embodiments of the present invention may be the computation of the bandwidth needed to meet a statistical QoS target.

We now describe two different methods of carrying out this computation. Both may be based on the following observations. For a wide range of different statistical models of network traffic, it is shown in “Large Deviations and Overflow Probabilities for the General Single-Server Queue” (N. G. Duffield and N. O'Connell, Mathematical Proceedings of the Cambridge Philosophical Society 118 (1995) pp. 363-374) that the distribution of packet delays at a queue from which traffic is transmitted at a constant rate may exhibit exponential decay for large delay values. In other words, the likelihood that an arriving packet will experience a delay D may decay exponentially in D when D is large. It may also be shown that the probability that a packet will be dropped due to buffer overflow when the buffer size is B may decay exponentially in B when B is large. In “The Large Deviations of Random Time Changes” (R. Russell, Ph.D. Thesis, School of Mathematics, Trinity College Dublin, 1997) it is shown that the exponential decay rates governing these phenomena can be computed from the statistical properties of the traffic in the following manner.

Suppose that T₁, T₂, T₃, . . . is an increasing sequence of random time values and V₁, V₂, V₃, . . . is an increasing sequence of traffic volumes, where Vₙ may represent the total volume of traffic seen so far at time Tₙ. The scaled cumulant generating function (sCGF) of the sequence of pairs (Vₙ, Tₙ) may be a real-valued function of two real variables or arguments θ and φ defined mathematically by the expression

$$μ ( θ , φ ) = {lim}_{n \to ∞} \frac{1}{n} log E exp ( θ {V}_{n} + φ {T}_{n} ) .$$

Here the symbol E may represent the mathematical expected value, or average, of the following random quantity. The times T₁, T₂, T₃, . . . can be chosen to represent the times of certain events in the traffic. (For example, we may choose them below to be the timestamps of the samples produced as output in the first stage of the analysis procedure). The exponential decay rate δ_{L} of the packet loss probability can be computed from the function μ(θ,φ) using the equation

δ_{L}=sup(θ: μ(θ,−θc)≦0),

where c is the bit-rate at which traffic is transmitted from the queue. In words, δ_{L} may be computed by finding the largest value of the variable θ such that μ(θ,−θc) is smaller than or equal to zero. The exponential decay rate δ_{D} of the packet delay distribution can also be computed from μ(θ,φ) by multiplying δ_{L} by the value c. These mathematical results may be valid no matter how the sequence of times T₁, T₂, T₃, . . . is chosen, provided that certain mild technical conditions are satisfied.

These facts imply that the function μ(θ, φ), if known, can be used to compute estimates of the bandwidth required to meet a statistical QoS delay target, as follows. Suppose that the QoS target may be a packet-delay target with delay parameter D and probability p (i.e. we wish to ensure that no more than a fraction p of the packets will be delayed for a time greater than D). If we approximate the packet-delay distribution using an exponential distribution with decay rate δ_{D}, then the QoS target may translate into a requirement that δ_{D} should be larger than the value −log(p)/D. The transmission bandwidth required to ensure this can be found using the following operations:
1. Set φ equal to −log(p)/D.
2. Find the largest positive value of θ for which μ(θ,−φ) may be less than or equal to zero. Such a value for θ may exist, because μ(0,−φ) is negative while the derivative of μ(θ,−φ) with respect to θ is positive when θ is positive (unless Vₙ is always zero, implying there is no traffic). μ(θ,−φ) may therefore be positive for sufficiently large θ.
3. Divide φ by this value of θ. The result may be the required transmission bandwidth.

In an analogous manner, the sCGF can be used to meet a statistical loss QoS target. If the QoS target is a packet-loss target with probability p, and the buffer space available is B, then the requirement may be that δ_{L} should be larger than −log(p)/B. We can find the required bandwidth as follows:
1. Set θ equal to −log(p)/B.
2. Find the smallest positive value of φ for which μ(θ,−φ) is less than or equal to zero. Such a value for φ may exist because μ(θ,0) is positive while the derivative of μ(θ,−φ) with respect to φ is negative when φ is positive. μ(θ,−φ) may therefore be negative for sufficiently large φ.
3. Divide this value of φ by θ to obtain the bandwidth.

It will be noted that this computation may require knowledge of the value of the function μ(θ,φ) for a fixed value of θ and multiple values of φ, while computing bandwidth requirement for a delay QoS target may require knowledge of the value of μ(θ,φ) for a fixed value of φ and multiple values of θ. We now discuss how these values can be estimated using a set of traffic samples such as those generated by the sample reduction procedure described above.

If the differences between successive time values T₂-T₁, T₃-T₂, T₄-T₃, . . ., and also the differences between successive volume values
V₂-V₁, V₃-V₂, V₄-V₃, . . ., can be represented as independent and identically-distributed random variables, then the expression defining μ(θ,φ) may reduce to the simpler expression

μ(θ,φ)=log E exp(θ(Vₖ₊₁-Vₖ)+φ(Tₖ₊₁-Tₖ)).

Here k may be any integer (the value of the expression is the same for all k). If we are presented with some number N of traffic samples containing observations of traffic volumes and timestamps, we can compute an estimate \hat{μ}(θ,φ) of the statistic μ(θ,φ) by replacing the mathematical expectation E with the empirical average of the observed values as follows:

$${μ}^{⋒} ( θ , φ ) = log \frac{1}{N - 1} {\sum }_{k - 1}^{N - 1} exp ( θ ( {V}_{k + 1} - {V}_{k} ) + φ ( {T}_{k + 1} - {T}_{k} ) ) .$$

This estimate can be expected to be close to the true value of the statistic provided that the traffic samples are indeed approximately independent observations and provided that N is reasonably large.

We now describe how to use the sample reduction procedure to compute \hat{μ}(θ,φ). Suppose first that the QoS target may be a packet-delay target with delay parameter D and probability p. In this case a packet-delay bandwidth test function with parameter D may be used in the sample reduction procedure. The samples produced may then be used to compute \hat{μ}(θ,−φ) using the above equation, with φ fixed and equal to −log(p)/B, and for multiple discrete values of θ. The bandwidth required to achieve the QoS target can then be computed from the estimated values of \hat{μ}(θ,−φ) using the operations already described above for packet delay QoS targets.

We note that \hat{μ}(θ,−φ) may be a convex function of θ and therefore, if its value is known for a number of discrete θ values, it can be approximated at other θ values using the ‘sandwich approximation’ method for convex functions (described for example in “The Convergence Rate of the Sandwich Algorithm for Approximating Convex Functions”, G. Rote, Computing 48 (1992) pp. 337-361). The choice of the discrete values for which to estimate \hat{μ}(θ,−φ) may normally need to be adjusted dynamically, so that the value of the estimate may be negative for the smallest θ value used and positive for the largest value. This may ensure that the bandwidth required to meet the QoS target can be computed accurately from the estimates using the operations described above. Choosing the number of discrete θ values at which to compute estimates may involve trading off the accuracy of the result against the increased computational cost of using a larger number of values. The effect of this choice on accuracy can be assessed using the sandwich approximation method, which may yield upper and lower bounds on \hat{μ}(θ,−φ) for values of θ which are not directly estimated. Using both of these upper and lower bounds to compute the required bandwidth may demonstrate the impact of the number of estimated values on the accuracy of the result. This assessment can be carried out using recorded traffic traces before the procedure is deployed for use, in order to determine how many values to use.

If the QoS target is a packet-loss target for a buffer of size B and probability p, then a packet-loss bandwidth test function may be used in the sample reduction procedure and the samples produced may be used to compute \hat{μ}(θ,−φ) as in the delay target case. This time however the estimates may be computed with θ fixed equal to −log(p)/B and for multiple values of φ, and the required bandwidth may be computed using the operations described above for packet-loss QoS targets.

The purpose of using the samples produced by the sample reduction procedure to compute \hat{μ}(θ,−φ), rather than an arbitrary set of samples, may be to achieve a good trade-off between the requirements of using widely-spaced samples (to achieve statistical independence), and using as few samples as possible (to arrive at an estimate quickly). If the samples are too widely-spaced then they may tend to miss important traffic events which contribute to queuing, so that more samples may be collected before an accurate estimate is produced. The sample reduction procedure may achieve a good compromise between these requirements because it may discard samples which do not impact bandwidth requirement while retaining those which do.

In particular, we have already seen that the pair of samples between which the largest bandwidth may meet the QoS target (over any sufficiently long window) may be retained as a consecutive pair of samples. We can demonstrate that when the samples are used to compute bandwidth requirement for a statistical QoS target using the procedure just described, the resulting bandwidth value may be greater than the bandwidth required between any consecutive pair of samples, with probability p. This fact holds even when the samples fail to be statistically independent, showing that use of the sample reduction procedure can help to prevent inaccuracies stemming from this origin.

To show this, suppose that the QoS target may be a statistical packet-loss target with probability p for a buffer of size B, and suppose that the above procedure for computing bandwidth requirement may produce the bandwidth value c. Let k be the label of a randomly chosen output sample from the sample reduction procedure. Applying Chernoff's inequality for probabilities, the likelihood that the bandwidth test function value s(k,k+1) exceeds c satisfies

P(s(k,k+1)>c)≦exp(−θB)E exp(θ(Vₖ₊₁-Vₖ)−θc(Tₖ₊₁-Tₖ))=exp(−θB)exp(μ(θ,−θc)),

for any positive value of θ. We can choose θ equal to −log(p)/B. Then the procedure for computing c may prescribe that c=φ/θ where φ satisfies μ(θ,−φ)≦0. For this value of c we therefore find that P(s(k, k+1)>c)≦p. The same result can be shown to hold in the case of a packet-delay QoS target.

We now describe a second method of computing bandwidth requirement for statistical QoS targets using the samples produced by the sample reduction procedure. This method may also rely on the exponential approximation for packet-delay and loss probabilities, but may use a different approach to compute estimates of the associated exponential decay rates δ_{D} and δ_{L}.

For a packet-delay QoS target with parameter D and probability p, the method may work by first applying the sample reduction procedure with the appropriate bandwidth test function, and then may compute the bandwidth required for every packet in the analysis window to meet the delay target D (for example using the procedure already described for deterministic QoS targets in FIG. 3). Next, the decay parameter δ_{D} for this bandwidth value may be estimated as follows.

Suppose that the window contains N packets, and consider a randomly selected subset of these of size αN where α is less than one. If the selected packets are spaced sufficiently far apart, we can assume that the delays they experience are approximately independent, as well as being exponentially distributed with parameter δ_{D}. The expected value of the maximum packet-delay Dₘₐₓ over this subset will be

$${ED}_{max} = \frac{1}{{δ}_{D}} ( 1 + \frac{1}{2} + \frac{1}{3} + … + \frac{1}{α N} ) \approx \frac{log ( α N ) + 0.6}{{δ}_{D}} .$$

This value may be less than D, which implies that

$${δ}_{D} \geq \frac{log ( α N ) + 0.6}{D} ,$$

a result which may be valid for any value of α which is not too large. This may be the estimate which is used for δ_{D}, for the particular bandwidth value obtained for the deterministic QoS target.

To find the bandwidth needed to meet the statistical QoS target, we may find the smallest bandwidth value which ensures that δ_{D}≧−log(p)/D. This may be achieved by applying the sample reduction procedure multiple times, using different delay targets. (The procedure can be applied several times either in parallel or using the ‘chaining’ configuration described earlier). For each resulting bandwidth value an estimate of δ_{D} may be computed as above. The least bandwidth value which meets the QoS target may then be determined. To achieve the final operation, we may need to interpolate between the computed δ_{D} values; this can be done using the ‘sandwich approximation’ method for convex functions, since δ_{D} may be a convex function of the transmission bandwidth.

The need to apply the sample reduction procedure multiple times may increase the computational cost of this approach but has the benefit of allowing any delay target within the range used to be analyzed using the results. For example, if we wish to be able to determine the bandwidth needed to meet any packet-delay target with delay parameter within the range 100 ms to 1000 ms, then we can apply the sample reduction procedure for delay targets 100 ms, 200 ms, 400 ms, 700 ms, and 1000 ms, and for each resulting bandwidth value may compute a corresponding δ_{D} estimate. For a given probability delay target within the specified range, we can then find the bandwidth value which ensures that δ_{D}≧−log(p)/D.

We note at this point that the two methods described for computing the required bandwidth for a statistical QoS target may require more complex numerical operations than the sample reduction procedure and the procedure for a deterministic QoS target. They may therefore be best implemented in software using floating point arithmetic. On a platform with no hardware floating point support, a software library providing such support can be used. Note that the second method described for computing the required bandwidth may not need to use floating point operations when a traffic sample is supplied, but only at those times when a bandwidth estimate is needed.

It will be appreciated that the techniques of embodiments of the present invention may provide a number of advantages over prior art attempts to analyze traffic on a packet network. Benefits include but are not limited to:
It is a procedure for computing the bandwidth that may be required by traffic to meet either a statistical or deterministic QoS target.
It can be used to compute the bandwidth required to meet either a packet-loss or a packet-delay target.
It may be computationally less expensive than other methods which have been proposed.
The bandwidth required to meet a deterministic QoS target can easily be computed using integer arithmetic operations only.
The bandwidth required to meet a statistical QoS target can be computed using mostly integer arithmetic operations and a limited number of floating point operations.
It may be suitable for implementation on measurement devices embedded in an operational network.

These and other advantages may be apparent to the person skilled in the art. It will also be understood that embodiments of the invention have been described with reference to implementations in embodiments but that these are purely exemplary of the application of the technique of embodiments of the present invention and are not intended to limit the application in any way except in the light of the appended claims. Furthermore, embodiments of the invention may be implemented in one or more software and/or hardware components as will be appreciated by the person skilled in the art. Such components may for example include registers, caches, buffers, processors and the like. Similarly, the words comprises/comprising when used in this specification are to specify the presence of stated features, integers, operations or components but does not preclude the presence or addition of one or more other features, integers, operations, components or groups thereof.

1. A method of processing measurement traffic samples at a node in a data packet network so as to provide a reduced set of samples for subsequent processing, the method comprising:
a) providing a plurality of measurement samples in an analysis buffer,
b) analysing the samples in the buffer to select a specific sample from the buffer, whereby said selection is effected by defining a first sample within the buffer and then selecting a second subsequent sample within the buffer, the second subsequent sample being selected on an analysis of the highest and average traffic values within an interval between the defined sample and subsequent samples
c) discarding all other samples in the buffer and using the selected sample as the defined sample for a subsequent iteration,
d) repeating a) to c) and
e) populating the reduced set of samples with the selected samples from b).

2. The method as claimed in claim 1 wherein each of the plurality of measurement samples has an associated time stamp (T) and traffic volume measurement value (V).

3. The method as claimed in claim 2 wherein the analysis of b) includes use of a bandwidth test function, the bandwidth test function taking as its input any two traffic samples i and j and producing as an output a bandwidth value, denoted s(i,j), computed from the information in i and j and from a predetermined quality of service target.

4. The method as claimed in claim 3 wherein the analysis of b) additionally includes a use of an average bit-rate, denoted r(i,j), observed between two samples, the average bit rate being the value of V(i,j)/T(i,j).

5. The method as claimed in claim 4 wherein the analysis utilises a combination of the average bit rate and the bandwidth test function to select the specific sample from the buffer.

6. The method as claimed in claim 5 including comparing the average bit rate to the bandwidth test function and wherein the selected sample is selected once the bandwidth test function is larger than the average bit rate.

7. The method as claimed in claim 3 wherein the bandwidth test function is a packet delay test function of the form s(i, j)=V(i, j)/(T(i, j)+D) where D is a specified delay value.

8. The method as claimed in claim 3 wherein the bandwidth test function is a packet loss test function of the form s(i, j)=(V(i, j)−B)/T(i, j) where B is a value equivalent to available buffer space.

9. The method as claimed in claim 3 further including determining the required bandwidth to ensure that a specified quality of service target is met, the determining being performed by maximising the value of s(i, j) over all consecutive samples in the reduced set.

10. The method as claimed in claim 1 wherein the analysis buffer is a circular buffer.

11. The method as claimed in claim 5 wherein b) is performed by assigning four variables to samples in the analysis buffer, the variables initially being assigned to the first sample, the method including subsequently:
maintaining a first variable of the four variables as a locator variable for the first sample,
first assigning a second variable of the four variables as a locator variable for a subsequent sample in the analysis buffer,
second assigning a third variable of the four variables as a locator variable for a sample located prior to the second variable which minimizes the value of the average bit rate for all samples between the first variable and the second variable,
third assigning a fourth variable of the four variables as a locator variable for a sample located prior to the second variable which maximizes the value of the bandwidth test function for all samples between the first variable and the second variable,
comparing the values of the third and fourth variables and on determination of the value of the bandwidth test function being greater than the value of the average bit rate, outputting the first of the third and fourth variable as the selected sample, discarding all other samples within the analysis buffer prior to this sample, reassigning all four variables to this sample and repeating said maintaining, said first, second, and third assigning, and said comparing.

12. The method as claimed in claim 11 including, on detecting that the number of samples in the analysis buffer is greater than the volume available in the analysis buffer, of outputting the first of the third and fourth variable as the selected variable to the reduced set irrespective of whether the value of the bandwidth test function is greater than the value of the average bit rate.

13. The method as claimed in claim 1 wherein the analysis buffer is populated at a rate τ which ensures that the value of the relationship τ/(T+D) where T is the length of an average interval which maximises the bandwidth test function and D is the delay bound of desired quality of service target is less than or equal to a specified tolerance level governing the maximum allowable error in the bandwidth result.

14. The method as claimed in claim 1 wherein a), b), c), d), and e) are used in a chaining configuration using different bandwidth test functions so as to determine a variation in the performance of the network under different conditions.

15. The method as claimed in claim 1 wherein the subsequent processing includes providing an estimate of the traffic's bandwidth requirement.

16. The method as claimed in claim 15 wherein the estimate of the traffic's bandwidth requirement is evaluated in a deterministic fashion, the bandwidth requirement being equivalent to a maximum bandwidth test function evaluation between consecutive samples in a pre-selected window of the reduced set of samples.

17. The method as claimed in claim 15 wherein the subsequent processing is a computation of the bandwidth needed to meet a statistical Quality of Service (QoS) target.

18. The method as claimed in claim 17 including using the reduced set to provide a scaled cumulant generating function (sCGF) representative of the traffic, the sCGF function having a first argument and a second argument, the sCGF being representative of the traffic activity within the network.

19. The method as claimed in claim 18 further including using the provided sCGF function to provide an estimate of the transmission bandwidth required in the network to meet a packet delay target.

20. The method as claimed in claim 19 wherein the transmission bandwidth is determined by:
calculating a packet delay target defined by the probability that the transmission bandwidth is within a defined loss bound, the quality target defining a second argument of the sCGF,
evaluating that sCGF function with a defined second argument to determine the largest value of the first argument of that sCGF for which the value of the sCGF function is less than or equal to zero, and
using the value of the first argument so determined in combination with the defined second argument to determine the transmission bandwidth.

21. The method as claimed in claim 18 further including using the provided sCGF function to provide an estimate of the transmission bandwidth required in the network to meet a packet loss target.

22. The method as claimed in claim 21 wherein the transmission bandwidth is determined by:
calculating a packet loss target defined by the probability that the transmission bandwidth is within a defined delay bound, the quality target defining a first argument of the sCGF,
evaluating that sCGF function with the defined first argument to determine the smallest value of the second argument of that sCGF for which the value of the sCGF function is less than or equal to zero, and
using the value of the second argument so determined in combination with the defined first argument to determine the transmission bandwidth.

23. The method as claimed in claim 17 wherein the bandwidth required to meet a statistical quality of service target is determined by:
defining multiple reduced sets in accordance with the steps of claim 1, each of the defined reduced sets differing in delay targets applied,
for each of the multiple reduced sets providing, in a deterministic fashion, an estimate of the traffic's bandwidth requirement, the bandwidth requirement values being equivalent to a maximum bandwidth test function evaluation between consecutive samples in a pre-selected window of the reduced set of samples.
for each of the multiple bandwidth values so defined, determining an associated exponential decay rate,
interpolating between each of the associated exponential decay rates to define a smallest bandwidth value that meets the quality of service target.

24. The method in accordance with claim 23 where the multiple reduced sets are provided in a chaining configuration such that a first reduced set is used as a basis for the determination of a subsequent reduced set.

25. The method in accordance with claim 24 where each subsequent reduced set is used as a basis for the next reduced set.

26. The method in accordance with claim 23 wherein the multiple reduced sets differ in the delay target used to determine the population of these sets, the delay target used for the calculation of the first reduced set being smaller than the delay targets used for subsequent reduced sets.

27. The method in accordance with claim 23 wherein each of the multiple reduced sets are provided in a parallel processing operation.

28. A computer program which when run on a computer is adapted to carry out the processing of measurement traffic samples at a node in a data packet network so as to provide a reduced set of samples for subsequent processing, the program being configured for
a) providing a plurality of measurement samples in an analysis buffer,
b) analysing the samples in the buffer to select a specific sample from the buffer, whereby said selection is effected by defining a first sample within the buffer and then selecting a second subsequent sample within the buffer, the second subsequent sample being selected on an analysis of the highest and average traffic values within an interval between the defined sample and subsequent samples
c) discarding all other samples in the buffer and using the selected sample as the defined sample for a subsequent iteration,
d) repeating a) to c) and
e) populating the reduced set of samples with the selected samples from b).

29. A network analysis tool configured to perform an analysis of network traffic at a specific node within a packet based network, the tool including:
a) a first analyser configured for providing a plurality of measurement samples in an analysis buffer,
b) a second analyser configured for analysing the samples in the buffer so as to select a specific sample from the buffer, the second analyser including selection means for defining a first sample within the buffer and then selecting a second subsequent sample within the buffer, the second subsequent sample being selected on an analysis of the highest and average traffic values within an interval between the defined sample and subsequent samples
c) a discard component configured for, on selection of a sample by the second analyser, for discarding all other samples in the buffer, and for providing the selected sample as a sample within a reduced set of samples, and
d) a processor configured for using the reduced set of samples in providing an analysis of the performance of the network.

30. The tool as claimed in claim 29 wherein the processor is configured for providing the analysis on the basis of user input quality of service criteria.

31. The tool as claimed in claims 29 wherein the tool is configured to perform one of a statistical or deterministic analysis of the bandwidth requirements of the network.
